(19) United States
(12) Patent Application Publication
(10) Pub. No.: US 2010/0271207 A1
(43) Pub. Date: Oct. 28, 2010

(54) ELECTRIC-SHOCK AND SMOKE-EMISSION CASH BOX

(76) Inventors: Chen-Sheng WANG, Taipei City (TW); Yun-Fu YANG, Taipei City (TW)

Correspondence Address: Muncy, Geissler, Olds & Lowe, PLLC, 4000 Legato Road, Suite 310, FAIRFAX, VA, 22033, US

(21) Appl. No.: 12/625,262

(22) Filed: Nov. 24, 2009

(30) Foreign Application Priority Data
Apr. 24, 2009 (TW) 98206998

(51) Int. Cl. G08B 13/14

(52) U.S. Cl. 340/568.1

(57) ABSTRACT

An electric-shock and smoke-emission cash box includes a case body, a controller, an anti-detachment security device, an alarm device, an electric-shock device, an electric-shock circuit, a smoke-emission device, a satellite positioning device, a radio signal transmission device, and a battery module. The anti-detachment security device is disposed in the case body, and emits a detached state signal to the controller by determining whether the case body is robbed. After receiving the detached state signal, the controller activates the alarm device, the electric-shock device, the electric-shock circuit, and the smoke-emission device, so as to provide multiple anti-robbery and alarm measures. Meanwhile, the satellite positioning device generates a satellite positioning coordinate in real time. The radio signal transmission device communicates with a control center through a mobile telecommunication network and transmits the satellite positioning coordinate or a related state to the control center, and is directly controlled by the control center.

### CROSS-REFERENCES TO RELATED APPLICATIONS

This non-provisional application claims priority under 35 U.S.C. § 119(a) on Patent Application No. 98206998 filed in Taiwan, R.O.C. on 2009/04/24, the entire contents of which are hereby incorporated by reference.

### BACKGROUND OF THE INVENTION

1. Technical Field

The present invention relates to a security device, and more particularly to an electric-shock and smoke-emission cash box integrating alarming, electric-shock, smoke-emission, and satellite positioning functions.

2. Related Art

Currently, for transport under security guard or cash transport for banks, a container such as a handbag or suitcase is mostly used for storing treasures or cash. The container is generally carried by one security personnel and guarded by other security personnel. The aforementioned container can not only store treasures and cash, but is also equipped with an alarm and anti-robbery device. The alarm and anti-robbery device includes a trigger switch, an alarm device, and an electric-shock device. The trigger switch has a pin and a pinhole. Once the pin is pulled out of the pinhole, the trigger switch activates the alarm device, and the alarm device issues an acoustic alarm. The electric-shock device includes a power source, a high-voltage coil, and electrically conductive wires. The electrically conductive wires are densely distributed at the handle of the handbag or suitcase, or densely distributed on a surface of the container. When the pin is pulled out of the pinhole, the trigger switch activates the power source of the electric-shock device with a delay (a period of time after the acoustic alarm is issues), and a high-voltage pulse current is generated by the high-voltage coil and transferred to the electrically conductive wires, so that any person contacting the container will receive an electric shock.

However, since the alarm and anti-robbery device cannot be activated unless the pin is pulled out. A robber may easily deactivated the alarming and electric-shock functions during the robbery by stopping the security personnel from pulling out the pin or by re-inserting the pin into the pinhole after the pin is pulled out. Meanwhile, the robber may also easily place the handbag or suitcase in a car or on a footrest of a scooter and escape quickly from the crime scene.

Even if the security personnel successfully remove the pin during the robbery, the robber may avoid contacting the high voltage on the handle by simply placing the handbag or suitcase in another handbag or suitcase, resulting in the loss of the anti-robbery function. Meanwhile, the handbag or suitcase can block the sound of the alarm device, so that the alarm and anti-robbery device fails to perform as an effective deterrent and alarm. Additionally, the alarm and anti-robbery device cannot provide direct warning to passersby or judicial personnel chasing the robber when the robber drives the car or scooter to escape.

Therefore, the existing alarm and anti-robbery device for transporting cash or treasures still has deficiencies resulting in it being easily disabled by the robber, and thus cannot protect effectively against robbery.

### SUMMARY

Accordingly, the present invention is directed to an electric-shock and smoke-emission cash box which has multiple anti-robbery mechanisms, so as to increase the difficulty in robbing the cash box.

To achieve the above objective, the present invention provides an electric-shock and smoke-emission cash box, which includes a case body, a controller, an anti-detachment security device, an alarm device, an electric-shock device and an electric-shock circuit, a smoke-emission device, a satellite positioning device, and a battery module. The case body has at least one interlayer. The controller is disposed in the interlayer, for receiving a detached state signal. The anti-detachment security device includes a pinhole switch, a pin, and a security belt. The security belt and the pin form a circuit loop, so that the pinhole switch maintains a secure state. When the pin is detached from the pinhole or the security belt is cut off, the pinhole switch generates the detached state signal to the controller. The alarm device is electrically coupled to the controller, and disposed in the interlayer of the case body. After receiving the detached state signal, the controller activates the alarm device to issue an acoustic alarm. The electric-shock device is disposed in the interlayer of the case body, and electrically coupled to the controller. The electric-shock circuit is distributed on an outer surface of the case body. After receiving the detached state signal, the controller activated the electric-shock device to generate a high-voltage current and transmit the high-voltage current to the electric-shock circuit. The smoke-emission device is electrically coupled to the controller. After receiving the detached state signal, the controller starts the smoke-emission device to generate an eye-catching smoke. The satellite positioning device is electrically coupled to the controller, and used for generating a satellite positioning coordinate. The radio signal transmission device is electrically coupled to the controller, and used for communicating with a control center through a mobile telecommunication network and transmitting the satellite positioning coordinate or a state of the pinhole switch to the control center. The battery module is used for supplying power, and is charged through an alternating current (AC) adaptor.

When the electric-shock and smoke-emission cash box is robbed and the pin is detached or the security belt is cut off, the pinhole switch issues a detached state signal to the controller. Alternatively, if a wireless distance monitoring device determines that the box is spaced at a distance from the cash transport vehicle or the security personnel by a certain distance, the controller is automatically started so as to sequentially activate the alarm device, the electric-shock device, and the smoke-emission device. Since the case body is not easy to carry, and the multiple anti-robbery and alarming mechanisms are activated by the controller, the difficulty in robbing the electric-shock and smoke-emission cash box is increased, thereby improving the security of cash or treasures transported under the guard of the security personnel.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional view of an embodiment of the present invention, in which a cover is closed;

FIG. 2 is a three-dimensional view of an embodiment of the present invention, in which a cover is opened;

FIG. 3 is a cross-sectional view of an embodiment of the present invention;

FIG. 4 is a circuit block diagram of an embodiment of the present invention; and

FIG. 5 is a schematic cross-sectional view of a smoke-emission device according to an embodiment of the present invention.

### DETAILED DESCRIPTION

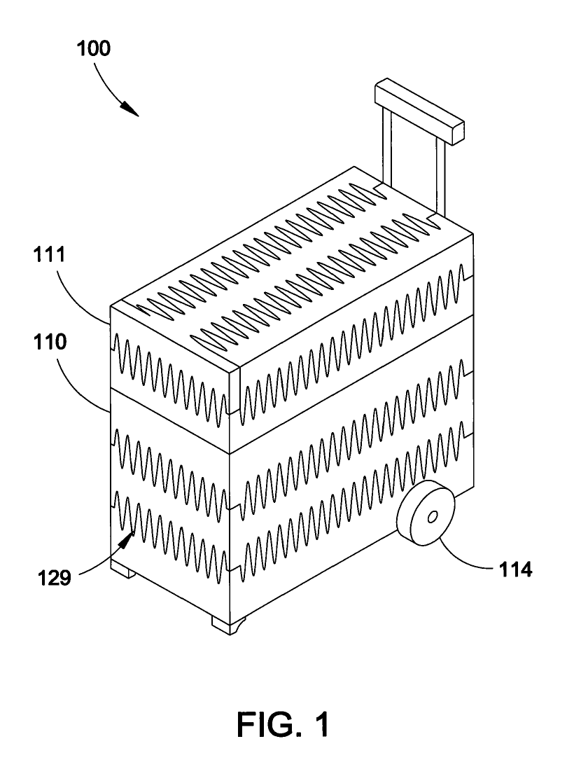

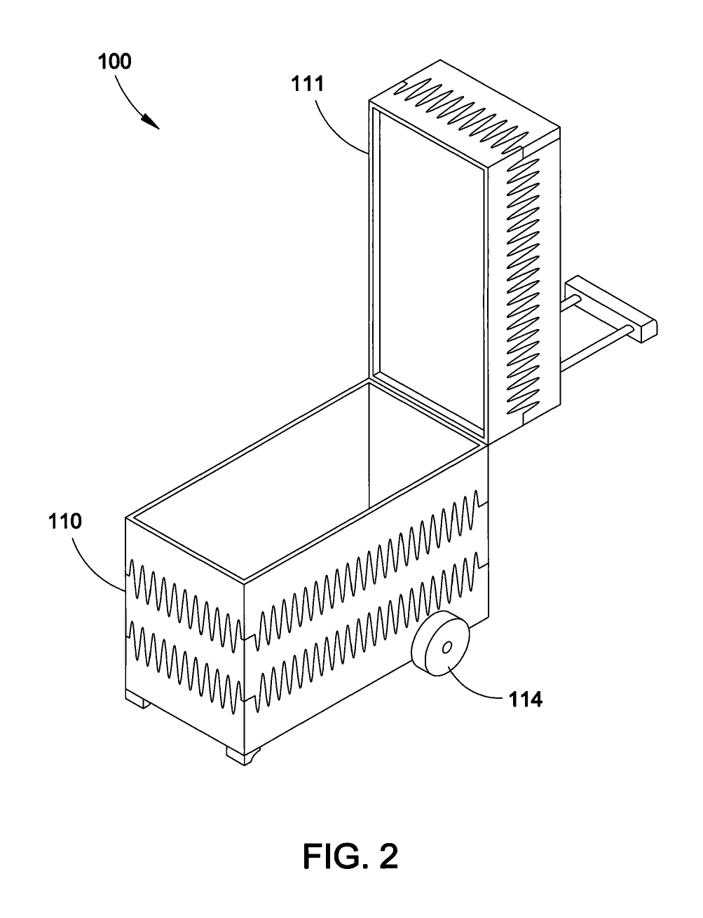

Referring to FIGS. 1 and 2, an electric-shock and smoke-emission cash box 100 according to an embodiment of the present invention is shown. The electric-shock and smoke-emission cash box includes a case body 110 and a security module.

The case body 110 is rectangular, and made of a high-hardness material such as stainless steel. The case body 110 includes a cover 111, and an opening of the case body 110 is exposed for placing cash or treasures after the cover 111 is opened. The cover 111 may be additionally provided with a lock for locking the cover 111. The case body 110 is not easily to be deformed and is large enough in size, and thus the case body 110 is not easily to be carried by the robber to the luggage compartment of a car or a scooter, thereby delaying the escape of the robber from the crime scene, and providing a long time for the security personnel to respond.

Referring to FIGS. 1, 2, and 3, the case body 110 includes a plurality of interlayer 112 for accommodating different components of the security module. The case body 110 further includes a plurality of wheels 114 and a retractable handle 115. The wheels 114 are disposed at a bottom of the case body 110, and the retractable handle 115 protrudes from a top surface of the case body 110, so as to allow the security personnel to drag the case body 110.

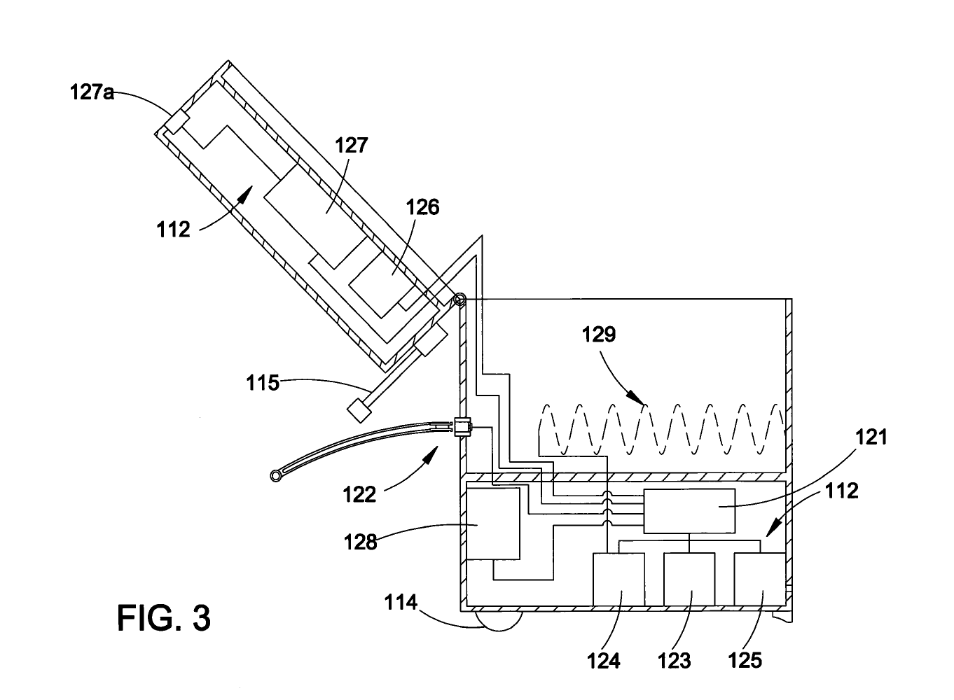

Referring to FIGS. 3, 4, and 5, the security module is disposed in the interlayer 112 of the case body 110. The security module includes an alarm device 123, an electric-shock device 124, a smoke-emission device 125, a satellite positioning device 126, a radio signal transmission device 127, and a battery module 128. The elements are all electrically coupled to a controller 121, respectively controlled by the controller 121, and respectively powered by the battery module 128. Moreover, the security module further includes an anti-detachment security device 122 for detecting whether the electric-shock and smoke-emission cash box 100 is detached from the security personnel on guard by an external force.

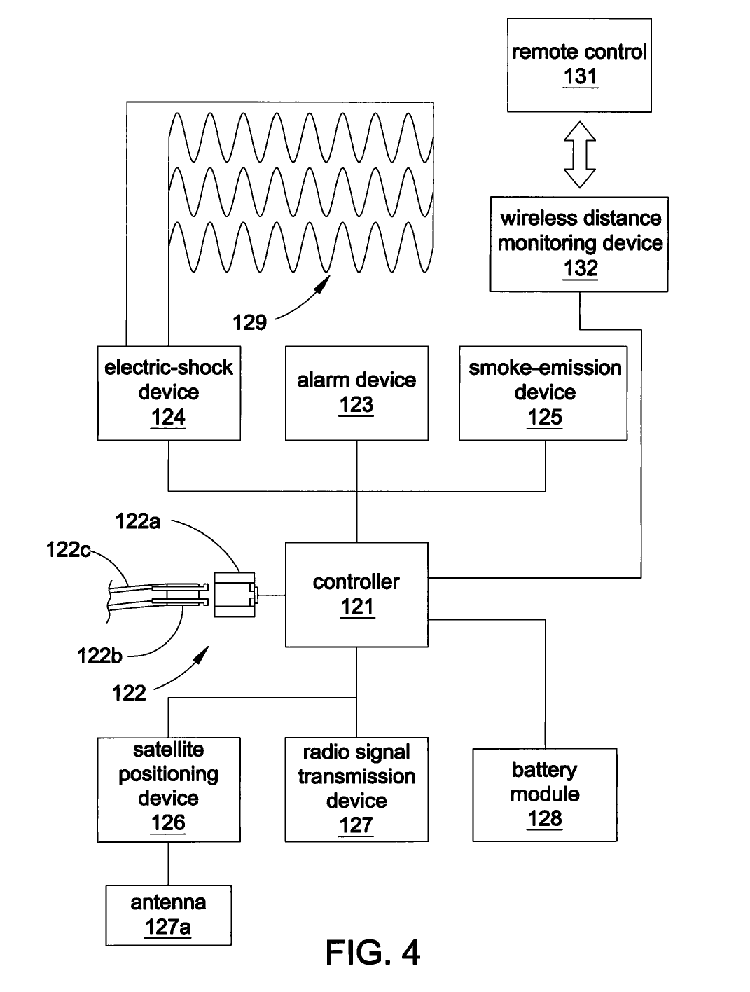

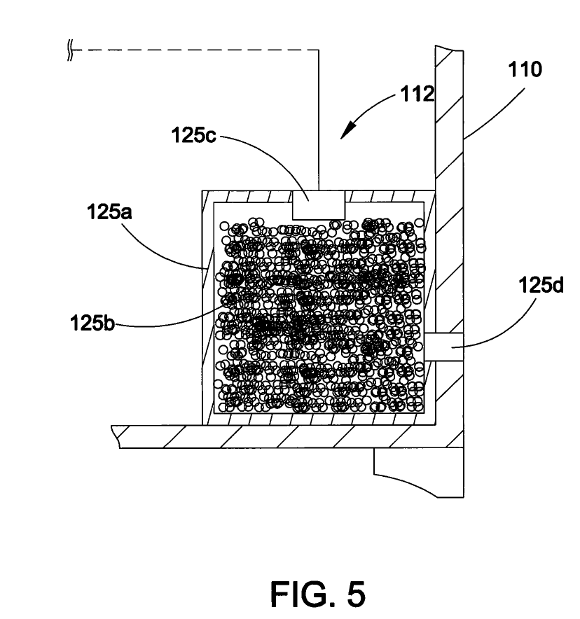

Referring to FIGS. 4, and 5, the anti-detachment security device 122 is electrically coupled to the controller 121. The anti-detachment security device 122 includes a pinhole switch 122a, a pin 122b, and a security belt 122c.The security belt 122c and the pin 122b form a circuit loop, so that the pinhole switch 122a maintains a secure state. The security belt 122c includes a folded wire connected to two electrodes of the pin 122b, and thus when the pin 122b is inserted into the pinhole switch 122a, a closed circuit loop is formed, and the pinhole switch 122a generates a secure state signal to the controller 121. When the pin 122b is detached from the pinhole or the security belt 122c is cut off, the pinhole switch 122a is disconnected to form an open loop, and generates a detached state signal to the controller 121. The security belt 122c is hung or fastened to the security personnel. When the electric-shock and smoke-emission cash box 100 is forcibly taken away from the security personnel, the belt body 123b drives the pin 122b to detach from the pinhole switch 122a, and the pinhole switch 122a issues a detached state signal. When the electric-shock and smoke-emission cash box 100 is spaced at a distance from the cash transport vehicle or the security personnel carrying the cash by a certain distance, the pin 122b is detached from the pinhole switch 122a, and the pinhole switch 122a automatically generates a detached state signal to the controller.

Referring to FIGS. 3 and 4, the alarm device 123 is electrically coupled to the controller 121, and disposed in the interlayer 112 of the case body 110. The alarm device 123 may be a speaker or a buzzer to issue a sound through a sound outlet of the case body 110. Upon receiving the detached state signal emitted by the pinhole switch 122a, the controller 121 initiates a timing, and activates the alarm device 123 to issues an acoustic alarm after the duration of the detached state signal exceeds an alarm timing period, for example, 5 seconds. The alarm timing period is set for the purpose of preventing the pin 122b from being pulled out accidentally due to an incorrect operation of the security personnel. When the pin 122b is pulled out accidentally due to incorrect operation, the alarm timing period allows the security personnel to temporarily release the setting of the controller 121, or to immediately insert the pin 122b back into the pinhole switch 122a, thereby avoiding a false alarm.

Referring to FIGS. 1, 2, 3, and 4, the electric-shock device 124 is disposed in the interlayer 112 of the case body 110, electrically coupled to the controller 121, and used for providing a high-voltage current after receiving a signal from the controller 121. An electric-shock circuit 129 is distributed on an outer surface of the case body 110 and the retractable handle 115, electrically coupled to the electric-shock device 124, and used for receiving the high-voltage current, so as to electrically shock a person contacting the case body 110. Meanwhile, the electric-shock circuit 129 includes a plurality of circuit loops, thereby preventing the loss of the electric-shock function due to a disconnection in a single circuit loop. Upon receiving the detached state signal emitted by the pinhole switch 122a, the controller 121 initiates a timing. The controller activates the electric-shock device 124 to generate a high-voltage current after the duration of the detached state signal exceeds an electric-shock timing period, for example, 10 seconds. The electric-shock timing period is set for the purpose of preventing the pin 122b from being pulled out accidentally due to incorrect operation by the security personnel. When the pin 122b is pulled out accidentally due to incorrect operation, the electric-shock timing period allows the security personnel to temporarily release the setting of the controller 121, or to immediately re-insert the pin 122b into the pinhole switch 122a, or refrain from contacting the case body 110 temporarily, thereby protecting the security personnel from an electric shock.

Referring to FIGS. 3, 4, and 5, the smoke-emission device 125 includes a combustion chamber 125a, a fuel 125b, and an ignition device 125c. The combustion chamber 125a is disposed in the interlayer 112 of the case body 110, and is in communication with the outside of the case body 110 through one or more smoke-emission ports 125d. The combustion chamber 125a is made of a high-temperature resistant material, and used for accommodating the fuel 125b. The ignition device 125c is at least partially located in the combustion chamber 125a, and is used for igniting the fuel 125b. The fuel 125b generates an eye-catching smoke, particularly red smoke, after burning. After the fuel 125b burns in the combustion chamber 125a, the smoke is emitted from the case body 110 through the smoke-emission ports 125d, so as to achieve a noticeable effect in order to indicate the position of the electric-shock and smoke-emission cash box 100, thereby solving the problem of the position of the electric-shock and smoke-emission cash box 100 being indeterminable when the alarm of the alarm device 123 is blocked out. The fuel 125b may further contain a lachrymator such as chloroacetophenone (CN) or o-chlorobenzylidene-malononitrile (CS), so that after the fuel bums, a tear gas is generated, and emitted from the case body 110 through the smoke-emission ports 125d to beat back the robbers. A plurality of smoke-emission ports 125d may be disposed, so as to emit the smoke from a plurality of outer surfaces of the case body 110. The ignition device 125c is electrically coupled to the controller 121, and used for receiving an ignition signal from the controller 121. Upon receiving the detached state signal emitted by the pinhole switch 122a, the controller 121 starts timing, and activates the ignition device 125c to ignite the fuel 125b to generate a smoke after the duration of the detached state signal exceeds a smoke-emission timing period, for example, 15 seconds. The smoke-emission timing period is set for the purpose of preventing the pin 122b from being pulled out accidentally due to incorrect operation by the security personnel. When the pin 122b is pulled out accidentally due to incorrect operation, the smoke-emission timing period allows the security personnel to temporarily release the setting of the controller 121, or to immediately insert the pin 122b back into the pinhole switch 122a, or refrain from contacting the case body 110 temporarily, thereby protecting the security personnel from an electric shock.

After the security module is activated by the controller 121, the alarm device 123, the electric-shock device 124, and the smoke-emission device 125 are activated sequentially, so as to generate multiple barriers against the robber. If the alarm device 123 cannot scare off the robber at the beginning, the electric-shock device 124 and the smoke-emission device 125 Referring to FIGS. 3 and 4, in which the satellite positioning device 126 is electrically coupled to the controller 121, and may normally operate or be passively started to generate a satellite positioning coordinate.

The radio signal transmission device 127 is electrically coupled to the controller 121, and includes an antenna 127a extending on a surface of the case body 110 for receiving a radio signal. The radio signal transmission device 127 is used for communicating with a control center through a mobile telecommunication network, and transmitting the satellite positioning coordinate or a state of the pinhole switch to the control center. The control center may also deliver a command, and transmit the command to the controller 121 through the radio signal transmission device 127, so that the controller 121 activates an alarming state and sequentially starts the alarm device 123, the electric-shock device 124, and the smoke-emission device 125. Meanwhile, the control center may also report the positioning coordinate to a judicial authority in real time, thereby rendering vain the deliberate hiding of the electric-shock and smoke-emission cash box 100 by the robber.

The battery module 128 includes a battery, a charging circuit, and a low-electric-quantity indicator. The battery is used for supplying power. The charging circuit is connected to an AC adaptor to charge the battery. The low-electric-quantity indicator emits a light or acoustic signal when the power of the battery is lower than a threshold value, so as to remind the security personnel or maintenance personnel of charging.

The present invention may further include a remote control 131 and a wireless distance monitoring device 132. The wireless distance monitoring device 132 is connected to the controller 131, and used for receiving a activate command or a deactivate command transmitted from the remote control 131 to start or turn off the security module, that is, to switch the controller 121 to an ON/OFF state. The security personnel may temporarily turn off the security module when taking out cash or changing cash or contacting the pin 122b by mistake. Meanwhile, the wireless distance monitoring device 132 may also provide a distance monitoring mechanism for monitoring a distance between the remote control 131 and the wireless distance monitoring device 132. When the distance exceeds a threshold value, it indicates that the security personnel is too far away from the electric-shock and smoke-emission cash box 100, and at this time the wireless distance monitoring device 132 transmits a monitoring result to the controller 121, and the controller 121 starts the security module.

The present invention ensures that the security module is started in case of robbery, thereby increasing the difficulty of robbing the cash box. Even if the security module fails to be started, the control center may also dynamically monitor the electric-shock and smoke-emission cash box 100 in real time, start the security module by remote after detecting an abnormal condition, obtain the position of the electric-shock and smoke-emission cash box 100, and provide the position to the security personnel or the judicial authority in order to pursue and apprehend the robber.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An electric-shock and smoke-emission cash box, comprising:
a case body, having at least one interlayer;
a controller, disposed in the interlayer, for receiving a detached state signal;
an anti-detachment security device, comprising a pinhole switch, a pin, and a security belt, wherein the security belt and the pin form an circuit loop, so that the pinhole switch maintains a secure state; and when the pin is detached from the pinhole or the security belt is cut off, the pinhole switch sends the detached state signal to the controller;
an alarm device, electrically coupled to the controller, and disposed in the interlayer of the case body, wherein after receiving the detached state signal, the controller activate the alarm device to issue an acoustic alarm;
an electric-shock device and an electric-shock circuit, wherein the electric-shock device is disposed in the interlayer of the case body and electrically coupled to the controller, the electric-shock circuit is distributed on an outer surface of the case body, and after receiving the detached state signal the controller activate the electric-shock device to generate a high-voltage current and transmit the high-voltage current to the electric-shock circuit; a smoke-emission device, electrically coupled to the controller, wherein after receiving the detached state signal, the controller activate the smoke-emission device to generate an eye-catching smoke;
a satellite positioning device, electrically coupled to the controller, for generating a satellite positioning coordinate;
a radio signal transmission device, electrically coupled to the controller, for communicating with a control center through a mobile telecommunication network and transmitting the satellite positioning coordinate or a state of the pinhole switch to the control center; and
a battery module, for supplying power, and charged through an alternating current adaptor.

2. The electric-shock and smoke-emission cash box as claimed in claim 1, wherein the case body comprises a cover, and an interior of the case body is exposed after the cover is opened.

3. The electric-shock and smoke-emission cash box as claimed in claim 1, further comprising a plurality of wheels and a retractable handle, wherein the wheels are disposed at a bottom of the case body, and the retractable handle protrudes from a top surface of the case body.

4. The electric-shock and smoke-emission cash box as claimed in claim 1, wherein the alarm device, the electric-shock device, and the smoke-emission device are activated sequentially.

5. The electric-shock and smoke-emission cash box as claimed in claim 1, wherein the alarm device is a speaker or a buzzer, and issues a sound through a sound outlet of the case body.

6. The electric-shock and smoke-emission cash box as claimed in claim 5, wherein the alarm device, the electric-shock device, and the smoke-emission device are activated sequentially.

7. The electric-shock and smoke-emission cash box as claimed in claim 1, wherein after receiving the detached state signal emitted by the pinhole switch, the controller activate the alarm device to issue an acoustic alarm after an alarm timing period.

8. The electric-shock and smoke-emission cash box as claimed in claim 7 wherein the alarm device, the electric-shock device, and the smoke-emission device are activated sequentially.

9. The electric-shock and smoke-emission cash box as claimed in claim 1, wherein after receiving the detached state signal emitted by the pinhole switch, the controller activates the electric-shock device to generate a high-voltage current after an electric-shock timing period.

10. The electric-shock and smoke-emission cash box as claimed in claim 9, wherein the alarm device, the electric-shock device, and the smoke-emission device are activated sequentially.

11. The electric-shock and smoke-emission cash box as claimed in claim 1, wherein the radio signal transmission device further comprises an antenna extending to a surface of the case body.

12. The electric-shock and smoke-emission cash box as claimed in claim 1, wherein the radio signal transmission device receives a command from a control center, and transmits the command to the controller, so as to enable the controller to sequentially activate the alarm device, the electric-shock device, and the smoke-emission device.

13. The electric-shock and smoke-emission cash box as claimed in claim 1, further comprising a remote control and a wireless distance monitoring device, wherein the wireless distance monitoring device is connected to the controller, for receiving a activate command or a deactivate command transmitted from the remote control.

14. The electric-shock and smoke-emission cash box as claimed in claim 10, wherein when a distance between the wireless distance monitoring device and the remote control exceeds a threshold value, the wireless distance monitoring device transmits a monitoring result to the controller.
